(19) United States
(12) Patent Application Publication
(10) Pub. No.: US 2025/0387750 A1
(43) Pub. Date: Dec. 25, 2025

(54) METHOD FOR TRAPPING AND STORING CO2

(71) Applicants: VICAT, L'Isle-d'Abeau (FR); INSTITUT NATIONAL DES SCIENCES APPLIQUEES DE LYON, Villeurbanne (FR); ECOLE SUPERIEURE DE CHIMIE PHYSIQUE ELECTRONIQUE DE LYON, Villeurbanne (FR); UNIVERSITE CLAUDE BERNARD LYON 1, Villeurbanne (FR); CENTRE NATIONAL DE LA RECHERCHE SCIENTIFIQUE, Paris (FR)

(72) Inventors: Laury BARNES-DAVIN, Voiron (FR); Emmanuel SCHMITT, Lyon (FR); Clara TOSI, Lyon (FR); Julien LECLAIRE, Theizé (FR)

(73) Assignees: VICAT, L'Isle-d'Abeau (FR); INSTITUT NATIONAL DES SCIENCES APPLIQUEES DE LYON, Villeurbanne (FR); ECOLE SUPERIEURE DE CHIMIE PHYSIQUE ELECTRONIQUE DE LYON, Villeurbanne (FR); UNIVERSITE CLAUDE BERNARD LYON 1, Villeurbanne (FR); CENTRE NATIONAL DE LA RECHERCHE SCIENTIFIQUE, Paris (FR)

(21) Appl. No.: 18/877,739

(22) PCT Filed: Jun. 19, 2023
(86) PCT No.: PCT/FR2023/050887

§ 371 Date: Dec. 20, 2024

(30) Foreign Application Priority Data
Jun. 20, 2022 (FR) 22/06008

(51) Int. Cl. B01D 53/14; B01D 53/62

(52) U.S. Cl. CPC B01D 53/1493; B01D 53/1475; B01D 53/62; B01D 2251/402; B01D 2251/404; B01D 2251/602; B01D 2251/604; B01D 2252/20494; B01D 2257/504; B01D 2258/0233

(57) ABSTRACT

Method for trapping and storing CO₂ by mechanochemical route including: a) dissolving an amine or amino acid to obtain a concentrated solution whose concentration of amine function is at least 3M; b) bringing the solution into contact with a CO₂-containing gas; c)1. bringing into contact under stirring the solution with an oxide, hydroxide, silicate, aluminate, phosphate, chloride or sulfate of alkaline earth metal or a material containing an oxide, silicate, aluminate, phosphate, chloride or sulfate of alkaline earth metal, the energy implemented for stirring being at least 2.5 W per gram; or 2. bringing into contact under grinding the precipitate with an oxide, hydroxide, silicate, aluminate, phosphate, chloride or sulfate of alkaline earth metal or a material containing an oxide, silicate, aluminate, phosphate, chloride or sulfate of alkaline earth metal, the energy implemented for grinding being at least 2.5 W per gram; and d) washing the obtained solid.

The present invention relates to a new method for trapping and storing CO₂.

The manufacture of the hydraulic binders, and in particular that of cements, consists essentially of calcining a mixture of carefully chosen and measured raw materials, also referred to as “raw”. The firing of this raw gives an intermediate product, clinker, which, when ground with calcium sulphate and possible mineral additions, will give cement. The type of manufactured cement depends on the nature and proportions of the raw materials as well as the firing method. There are several types of cement: Portland cements (which represent the vast majority of cements produced in the world), aluminous cements (or calcium aluminate cements), natural quick-setting cements, sulfo-aluminous cements, sulfo-belitic cements and other intermediate varieties.

The most widespread cements are Portland-type cements. Portland cements are obtained from Portland clinker, obtained after clinkerization at a temperature in the range of 1450° C. of a raw rich in calcium carbonate in a kiln. The production of one tonne of Portland clinker is accompanied by the emission of significant quantities of CO₂ (around 0.8 to 0.9 tonnes of CO₂ per tonne of cement in the case of a clinker).

However, in 2014, the quantity of cement sold in the world was around 4.2 billion tonnes (source: Syndicat Français de l′Industrie Cimentière—SFIC). This figure, which is constantly increasing, has more than doubled in 15 years.

During the production of clinker, the main constituent of Portland cement, the release of CO₂ is linked to:
up to 40% for heating the cement kiln, grinding and transport;
up to 60% for so-called chemical CO₂, or decarbonation.

Decarbonation is a chemical reaction that occurs when limestone, the main raw material for the manufacture of Portland cement, is heated to high temperatures. The limestone is then transformed into quicklime and CO₂ according to the following chemical reaction:

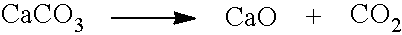

To reduce CO₂ emissions linked to the production of Portland cement, several approaches have been considered so far:
the adaptation or modernization of cementitious methods in order to maximize the efficiency of the thermal exchanges;
the development of new “low carbon” binders such as sulfo-aluminous cements prepared from raw materials with less limestone and at a lower firing temperature, which allows a reduction in CO₂ emissions of around 35%;
or the (partial) substitution of the clinker in cements by materials which limit CO₂ emissions.

Technologies for trapping and storing carbon have also been developed to limit CO₂ emissions from cement plants or coal-fired power plants. Unfortunately, these technologies have not reached the technological development that allows for large-scale application. In addition, these technologies are expensive.

International patent application WO-A-2019/115722 describes a method for both cleaning CO₂-containing exhaust gases and manufacturing an additional cementitious material. The method described involves using recycled concrete fines comprising providing recycled concrete fines with d₉₀≤1000 μm in stockpiles or a silo as a starting material, rinsing the starting material to provide a carbonaceous material, removing the carbonaceous material and the cleaned exhaust gas, and deagglomerating the carbonaceous material to form the additional cementitious material, as well as using stockpiles or a silo containing a starting material of recycled concrete fines with d₉₀≤1000 μm for cleaning CO₂-containing exhaust gases and simultaneously manufacturing an additional cementitious material. However, to be economically and industrially viable, this method requires that the waste be located close to the CO₂ source. In addition, the CO₂ fixation reaction takes place on a solid matrix, the kinetics are slow and the yields in terms of CO₂ content sequestered in the solid matrix are low.

At the date of the present invention, it therefore remains necessary to identify new methods for trapping and storing the CO₂ contained in industrial exhaust gases, in particular in exhaust gases from cement production, the kinetics and efficiency of which make it possible to significantly reduce CO₂ emissions and an implementation which is industrially and economically viable.

Among the various techniques for trapping and storing CO₂, the so-called “integrated absorption mineralization” or “IAM” route has been the subject of numerous studies, such as those of Meishen Liu et al., “Integrated CO₂ Capture, Conversion, and Storage To Produce Calcium Carbonate Using an Amine Looping Strategy”, Energy Fuels, 2019, 33, 1722-1733, and “Integrated CO₂ Capture and Removal via Carbon Mineralization with Inherent Regeneration of Aqueous Solvents”, Energy Fuels, 2021, 35, 8051-8068.

This route can be summarized by the following reaction scheme:

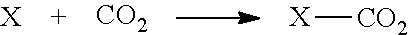

then

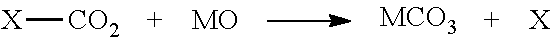

in which X denotes the CO₂ sensor and M denotes a mineral, in particular a mineral rich in calcium or magnesium.

It mainly consists of trapping CO₂ using a solvent and then bringing the solution thus obtained into contact with a mineral acceptor such as CaO or MgO in order to carbonate it and thus obtain an insoluble and stable carbonate.

Studies on the IAM route have been the subject of numerous publications.

The CO₂ absorbents mainly used so far have been industrial amines, in particular monoethanolamine (MEA), diethanolamine (DEA), N-methyldiethanolamine (MDEA), 2-amino-2methylpropanol (AMP), and piperazine 1,8-diazabicyclo[5.4.0]undec-7-ene (DBU). However, in the IAM strategy, a crucial point for industrial development concerns the loss of the amine in the formed mineral carbonate matrix. Indeed, this sequestration induces a double economic penalty for a potential method:
consumption of absorbent during IAM cycles and necessary replenishment; and
reduction in the market value of the formed carbonate.

Furthermore, the eco-toxicity of the used industrial amines greatly reduces the possibilities of using the carbonate finally formed.

As a result, research has focused on the use of an alkaline amino acid salt, sodium glycinate (NaGly), to trap CO₂, particularly because of its environmental safety.

Regardless of the used CO₂ absorbent, the method implemented consists of a closed system “one-pot” method in which the mineral acceptor is suspended in a solution of CO₂ absorbent contained in a reactor under a constant atmosphere at pCO₂=1 atm, the depression induced by the absorption of CO₂ being compensated by the constant supply of CO₂-containing gas. Once the reaction is complete, the solid (carbonate mineral acceptor) and liquid are separated by filtration, the solid is washed and the liquid phases are combined for reuse.

In this method, the carbonation of the mineral acceptor therefore takes place in a liquid medium, and a large quantity of water is thus necessary for its implementation, which poses a difficulty, particularly from an environmental point of view. In addition, carbonation requires high temperatures (around 80° C.), which therefore consumes energy and reduces the solubility of CO₂ in the liquid phase. Finally, the reaction kinetics are low and the regeneration rate of the CO₂ absorbent is not high enough, which calls into question the economic viability of the method.

It would therefore be interesting to identify new methods for implementing the “IAM” route with reaction kinetics and yields that are acceptable from an industrial point of view, and which would make it possible to limit the quantity of water used as well as sufficient regeneration of the used CO₂ absorbent.

In “Integrated CO₂ Capture and Removal via Carbon Mineralization with Inherent Regeneration of Aqueous Solvents”, Energy Fuels, 2021, 35, 8051-8068, the authors Meishen Liu et al. study a method for trapping CO₂ involving the formation of carbonates, in particular the “IAM” method, consisting of trapping a fraction of the CO₂ contained in large excess in a reactor using a solvent (MEA, NaGly, NaOH, AMP or DBU) in the presence of a mineral acceptor such as CaO, CaSiO₃ and MgO in order to carbonate it and thus obtain a carbonate insoluble and stable (see “Introduction” and “Materials & methods”). The concentration of the amine solutions tested ranged from 0.5M to 5M, but the authors report that the use of amine solutions (notably AMP and DBU) with a concentration higher than 1M inhibits (at least partially) mineralization carbon due to the formation of viscous, gel-like fluids. The use of solutions with an amine concentration of less than 1M involves the use of significant amounts of water. In addition, only a fraction (minor) of the CO₂ contained in the reservoir is thus mineralized.

Now, a method of implementing the IAM route has been found that significantly limits the quantities of water required compared to the methods implemented to date. Furthermore, the reaction kinetics, the yield and the regeneration rate of the used CO₂ absorbent are significantly higher than for the methods conventionally used.

Thus, the subject of the present invention is a method for trapping and storing CO₂ comprising the following steps:
a) dissolving an amine or an amino acid in order to obtain a concentrated solution whose concentration of amine function is at least 3M;
b) bringing the solution thus obtained into contact with a CO₂-containing gas;
c) 1. bringing into contact, while stirring, the concentrated solution obtained in step b) with an oxide, a hydroxide, a silicate, an aluminate, a phosphate, a chloride or a sulfate of alkaline earth metal or a material containing an oxide, a silicate, an aluminate, a phosphate, a chloride or a sulfate of alkaline earth metal, the energy implemented for stirring being at least 2.5 W per gram of the stirred sample;
   or
   2. bringing into contact under grinding the precipitate obtained in step b) with an oxide, a hydroxide, a silicate, an aluminate, a phosphate, a chloride or a sulfate of alkaline earth metal or a material containing an oxide, a silicate, an aluminate, a phosphate, a chloride or a sulfate of alkaline earth metal, the energy implemented for grinding being at least 2.5 W per gram of the ground sample; and
d) washing the obtained solid.

The method according to the present invention therefore allows the use of a concentrated solution of amine or amino acid to trap the CO₂, and the obtaining of a precipitate or a concentrated solution containing the CO₂, and, consequently, the carrying out of the step of carbonating the alkaline earth metal oxide by dry route or in the presence of small quantities of water, which significantly limits the quantities of water required in comparison with the methods implemented up to now. Furthermore, the reaction kinetics, the yield and the regeneration rate of the used CO₂ absorbent are significantly higher than for the methods conventionally used.

In the context of the present invention:
“amino acid” means any amino acid known to those skilled in the art, in particular amino acids of the following general formula (I) or (II):

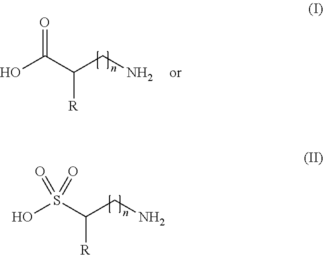

in which
   R represents a hydrogen atom, a C₁-C₅-alkyl group optionally substituted by at least one group chosen from hydroxyl, amino; —C(O)—OH; —S(O)₂—OH; —C(O)—O⁻, M+; —S(O)₂—O⁻, M+;
   M+ representing a cationic counterion such as alkali metal, alkaline earth metal, or ammonium;
   n is 0 or 1;
as well as their optical isomers and their alkali salts;
“proteinogenic amino acid” means any amino acid chosen from alanine (Ala), arginine (Arg), asparagine (Asn), aspartate (Asp), cysteine (Cys), glutamate (Glu), glutamine (Gln), glycine (Gly), histidine (His), isoleucine (III), leucine (Leu), methionine (Met), phenylalanine (Phe), proline (Pro), pyrrolysine (Pyl), selenocysteine (Sec), serine (Ser), threonine (Thr), tryptophan (Trp), tyrosine (Tyr), valine (Val) and lysine (Lys) or one of its derivatives of formula (III)

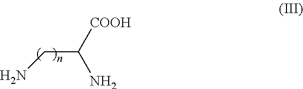

in which n is an integer equal to 1, 2, 3 or 5,
as well as their optical isomers and their alkali salts; and
“amine” means any compound comprising at least one primary or secondary amine function. Preferably, “amine” denotes any compound comprising at least one primary amine-type function;
“alkaline salt” means any addition salt obtained with a mineral or organic base by the action of such a base within an organic or aqueous solvent such as an alcohol, a ketone, an ether or a chlorinated solvent. Examples of such salts include, in particular, ammonium (NH₄⁺), calcium (Ca²⁺), iron (II) (Fe²⁺) or (III) (Fe³⁺), magnesium (Mg²⁺), potassium (K⁺), sodium (Na⁺) or lithium (Li⁺) salts. Preferably, “alkaline salt” means a lithium, potassium or sodium salt;
“concentrated solution” means any aqueous or organic solution, excluding suspensions, whose concentration of amine function is at least 3M, preferably at least 4M, preferably at least 5M, more preferably at least 6M and most preferably at least 8M; and
“mechanochemical route” means any route implementing a chemical reaction induced by the absorption of mechanical or kinetic energy.

Step a) of the method according to the present invention therefore corresponds to a step of dissolving an amine or an amino acid in an organic solution.

Preferably, step a) of the method according to the present invention is carried out under the following conditions, taken alone or in combination:
the amine is chosen as being ethylenediamine (EDA), diethylenetriamine (DETA), monoethanolamine (MEA), diethanolamine (DEA), N-methyldiethanolamine (MDEA), 2-amino-2methylpropanol (AMP), piperazine, 1,8-diazabicyclo[5.4.0]undec-7-ene (DBU), cadaverine, putrescine, spermidine or spermine. More preferably, the amine is chosen as being ethylenediamine (EDA), diethylenetriamine (DETA), monoethanolamine (MEA), diethanolamine (DEA), N-methyldiethanolamine (MDEA), 2-amino-2methylpropanol (AMP), piperazine and 1,8-diazabicyclo[5.4.0]undec-7-ene (DBU). Most preferably, the amine is chosen as being monoethanolamine (MEA), diethanolamine (DEA), N-methyldiethanolamine (MDEA), 2-amino-2methylpropanol (AMP), piperazine or 1,8-diazabicyclo[5.4.0]undec-7-ene (DBU);
the amino acid is chosen as being a proteinogenic amino acid. Preferably, the amino acid is chosen as being arginine (Arg), asparagine (Asn), aspartate (Asp), cysteine (Cys), glycine (Gly), histidine (His) or lysine (Lys), as well as their optical isomers and their alkali metal salts. More preferably, the amino acid is chosen as being L-arginine (L-Arg), L-asparagine (L-Asn), L-aspartate (L-Asp), L-cysteine (L-Cys), glycine (Gly) or L-lysine (L-Lys) or one of its derivatives of formula (III)

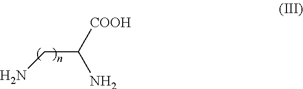

in which n is an integer equal to 1, 2, 3 or 5,
as well as their alkaline salts. Preferably, the amino acid is chosen as being an alkaline salt of L-lysine (L-Lys) or one of its derivatives of formula (III)

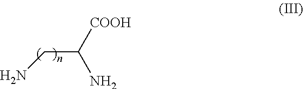

in which n is an integer equal to 1, 2, 3 or 5. Most preferably, the amino acid is chosen as being an alkaline salt of L-lysine (L-Lys);
the concentration of amine function in the solution is at least 4M, more preferably at least 5M, more preferably greater than 5M, more preferably at least 6M, and most preferably at least 8M;
the concentration of amine function in the solution is at most 50M, preferably at most 25M, more preferably at most 15M, most preferably at most 10M; and/or
the amine or amino acid is dissolved in an aqueous solution or an organic solution. Preferably, the amine or amino acid is dissolved in water or a mixture of water and alcohol, the water:alcohol ratio of which is preferably comprised between 1:10 and 10:1, more preferably between 1:5 and 5:1. Preferably, the alcohol is chosen as being methanol, ethanol, propanol, or isopropanol; more preferably, the alcohol is chosen as being methanol.

At the end of step a) of the method according to the present invention, the obtained solution is brought into contact with a CO₂-containing gas (step b)).

Preferably, step b) of the method according to the present invention is carried out under the following conditions, taken alone or in combination:
the CO₂-containing gas is an industrial combustion or exhaust gas. Preferably, the CO₂-containing gas is an exhaust gas from a cement plant, a steel plant, a coal, gas or oil-fired power plant. More preferably, the CO₂-containing gas is an exhaust gas from a cement plant or a coal-fired power plant;
the contacting is performed at a temperature ranging from 10° C. to 70°, preferably from 15° C. to 65° C., more preferably from 20° C. to 60° C.; and/or
the contacting is performed under a total pressure ranging from 0.7 to 10 Bars, preferably from 0.8 to 5 Bars, more preferably from 1 to 3 Bars.

At the end of step b) of the method according to the present invention, the concentrated solution or the obtained precipitate is brought into contact with an oxide, a silicate, an aluminate, a phosphate, a chloride or a sulfate of alkaline earth metal or a material containing an oxide, a silicate, an aluminate, a phosphate, a chloride or a sulfate of alkaline earth metal under grinding or stirring (step c)). Preferably, step c) of the method according to the present invention is carried out under the following conditions, taken alone or in combination:
the concentrated solution or obtained precipitate is brought into contact with an alkaline earth metal oxide or silicate or a material containing an alkaline earth metal oxide or silicate;
the alkaline earth metal oxide is chosen as being CaO or MgO;
the alkaline earth metal silicate is chosen as being CaSiO₃ or MgSiO₃;
the alkaline earth metal hydroxide is chosen as being Ca(OH)₂ or Mg(OH)₂;
the contacting is performed in the presence of water or a water/solvent mixture; and/or
the contacting is performed at a temperature ranging from 10° C. to 40°, more preferably from 15° C. to 30° C. Most preferably, the contacting is performed at room temperature;
the energy implemented for stirring or grinding is at least 10 W per gram of stirred or ground sample, preferably at least 15 W per gram of stirred or ground sample, most preferably at least 20 W per gram of stirred or ground sample; and/or
the energy implemented for stirring or grinding is at most 500 W per gram of stirred or ground sample, preferably at most 200 W per gram of stirred or ground sample, most preferably at most 100 W per gram of stirred or ground sample.

The stirring of the concentrated solution can be performed with any suitable equipment known to those skilled in the art.

The grinding of the precipitate can be performed with any suitable equipment known to those skilled in the art. Preferably, the grinding of the precipitate is performed with a planetary mill, a ball mill, a knife mill, a ring mill or via grinding in a jar with ceramic balls.

When a precipitate is obtained at the end of step b), it is preferably filtered and washed before being brought into contact with an oxide, a silicate, an aluminate, a phosphate, a chloride or a sulfate of alkaline earth metal or a material containing an oxide, a silicate, an aluminate, a phosphate, a chloride or a sulfate of alkaline earth metal under grinding during step c). Preferably, the filtration and washing are carried out under the following conditions, taken alone or in combination:
the washing is performed with a solution containing water and/or alcohol. More preferably, the washing is performed with a mixture of water and alcohol, the water:alcohol ratio of which is preferably comprised between 1:1 and 1:5. Preferably, the alcohol is chosen as being methanol, ethanol, propanol, or isopropanol; more preferably, the alcohol is chosen as being methanol;
the washing solutions are combined and reused in step a) of the method according to the invention;
the washing is followed by a drying step. Preferably the washing is followed by a drying step carried out at a temperature ranging from 5° C. to 400° C., more preferably at a temperature ranging from 20° C. to 300° C.; and/or
the filtration and washing are carried out under vacuum.

At the end of step c) of the method according to the present invention, the obtained solid is filtered and washed (step d)). Preferably, step d) of the method according to the present invention is carried out under the following conditions, taken alone or in combination:
the washing is performed with water;
the washing solutions are combined and reused in step b) of the method according to the invention; and/or
the washing is followed by a drying step. Preferably the washing is followed by a drying step carried out at a temperature of up to 400° C.

The alkaline earth metal carbonates obtained at the end of the method according to the present invention are insoluble and stable and therefore allow CO₂ to be stored sustainably. They are also reusable in various ways, for example as filler in cement production, as mineral filler in various products or as amendment.

The present invention may be illustrated in a non-limiting manner by the following examples.

### EXAMPLE 1—METHOD FOR TRAPPING AND STORING CO₂ ACCORDING TO THE INVENTION

### 1.1—Trapping CO₂

### a/ Method

### Amino Acid

1 g of amino acid and one equivalent of KOH are dissolved in 6 ml of a distilled water/methanol mixture in a water:methanol ratio of 1:5.

CO₂ is introduced into the solution thus formed at 200 mg/min for 1 hour. The formation of a white precipitate is observed.

At the end of the reaction, the precipitate is filtered on a frit, washed cold with a mixture of water/methanol (ratio 1:5) and dried under vacuum for 12 hours.

The injected quantity of CO₂ is monitored by gravimetry and the total load of trapped CO₂ is confirmed by quantitative 13C NMR analysis.

The amino acids used in this method are lysine, glycine and cysteine.

### Industrial Amine

A concentrated 5M solution of diethylenetriamine (DETA) is prepared from commercial DETA and distilled water in a graduated flask.

The solution is charged with a CO₂ flow of 200 mg/min using a flow meter.

The injected quantity of CO₂ is monitored by gravimetry and the total load of trapped CO₂ is confirmed by quantitative 13C NMR analysis.

### b/ Results

TABLE 1
Amount of CO₂ trapped by the amino acid or amine

| | Amount of CO₂ trapped by the amino |
|---|---|
| Amino acid/Amine | acid/amine |
| GlyK | 0.61 |
| LysK | 0.77 |
| CysK | 0.61 |
| DETA | 0.45 |

In this table, the amount of CO₂ trapped by the amino acid/amine corresponds to the ratio of moles of CO₂/moles of nitrogen.

### 1.2—Storing CO₂

### a/ Method

### i) Dry Grinding

0.3 g of solid α-amino acid-CO₂ obtained in example 1.1 is introduced into a 20 ml tungsten carbide (WC) mechanochemistry reactor with 60 5 mm diameter balls.

The alkaline earth metal oxide is introduced in stoichiometric quantity relative to the CO₂.

Grinding is performed at 500 rpm for 30 minutes.

The resulting solids are collected using 5 ml of distilled water, centrifuged and washed 3 times.

The liquid and solid phases are separated and dried via a freeze dryer.

### ii) Liquid Assisted Grinding (LAG—Amino Acid

0.3 g of solid α-amino acid-CO₂ obtained in example 1.1 is introduced into a 20 ml tungsten carbide (WC) mechanochemistry reactor with 60 5 mm diameter balls.

The alkaline earth metal oxide is introduced in stoichiometric quantity relative to the CO₂.

A defined amount of water is added into the reactor with a liquid:solid ratio comprised between 0.1 and 2 μL/mg.

Grinding is performed at 500 rpm for 30 minutes.

The resulting solids are collected using 5 ml of distilled water, centrifuged and washed 3 times.

The liquid and solid phases are separated and dried via a freeze dryer.

iii) Liquid Assisted Grinding (LAG)—Amine

1 ml of the DETA-CO₂ solution obtained according to example 1.1 is introduced into a 20 ml tungsten carbide (WC) mechanochemistry reactor with 60 5 mm diameter balls.

The alkaline earth metal oxide is introduced in stoichiometric quantity relative to the CO₂.

Grinding is performed at 500 rpm for 30 minutes.

The resulting solids are collected using 5 ml of distilled water, centrifuged and washed 3 times.

The liquid and solid phases are separated and dried via a freeze dryer.

### b/ Results

### Regeneration Rate of the Amino Acid/Amine

The regeneration rate of the amino acid or amine is determined by elementary analysis of the quantity of nitrogen N in the solid according to the following procedure, which corresponds to: (number of introduced moles-number of retained moles)/number of introduced moles×100.

The solid phase is analyzed by CHNS in order to obtain the mass percentage of the various present elements. The percentage can be converted into moles of each element according to the following equations:

$$\% N / 100 = g N in 1 g of solid sample \qquad ( 1 )$$

$$\begin{matrix}Eq . ( 1 ) & \\ x exact mass of the sample = g N in the sample studied & ( 2 )\end{matrix}$$

$$\begin{matrix}Eq . ( 2 ) & \\ / 14.008 ( atomic mass of nitrogen ) = moles of N & ( 3 )\end{matrix}$$

After obtaining the number of moles of N in the sample, the number of moles of amino acid/amine is obtained by dividing the number of moles of nitrogen by the number of nitrogens present on the amine (e.g. 3 for DETA and 2 for lysine):

$$Moles of N ( 3 ) / \#nitrogens present on the amino acid / amine = moles of amino acid / amine \qquad ( 4 )$$

From the number of moles of amine in the solid sample, the amino acid/amine regeneration rate (RR) can be calculated according to the following equation:

$$TR ( \% ) = ( Moles of initial amino acid / amine - moles of amino acid / amine in the sample ) / moles of initial amino acid / amine \qquad ( 5 )$$

### Carbonation Rate of the Alkaline Earth Metal Oxide

The carbonation rate of the alkaline earth metal oxide (ratio of moles of CO₂ fixed in the solid phase per mole of alkaline earth metal oxide) is determined:
by volumetric titration of the CO₂ expelled during the acid digestion of the solid obtained (dosage of the so-called “inorganic” carbonate) on a Chittick apparatus with a 3 ml burette: an aliquot of dry solid of approximately 10 mg is titrated with 1 ml of 1M H₂SO₄ acid. The calibration of the apparatus is done beforehand with NaHCO₃titrated with 1M H₂SO₄, thus obtaining a calibration curve of y=13.225 with R₂=0.9943;
and by elementary analysis of the carbon content (called total) after deduction of the possible contribution of the trapped amine: the nitrogen content of the solid makes it possible to go back to the quantity of amine and therefore of carbon coming from the amine in the solid. Subtracted from the quantity of total carbon in the solid, we deduce the quantity of carbon coming from the fixed CO₂

These two measurements are confirmed by q13C NMR on the liquid phases to confirm the amount of amine: an aliquot of the liquid phase is analyzed by NMR in the presence of an internal reference to allow quantification of the amine in solution.

The carbonation rate is calculated following the same principle as for calculating the regeneration rate of the amine/amino acid.

Equations (1), (2) and (3) above are adapted by dividing by the atomic mass of carbon.

The number of moles of CO₂ in the solid phase is calculated by subtracting the number of moles of amino acid/amine from the number of moles of carbon:

$$Moles of CO 2 = moles of C - ( moles of amino acid / amine x \#C in amino acid / amine ) \qquad ( 6 )$$

In equation 6 the number of moles of amine were calculated by eq. (4) and the #C varies according to the amino acid/amine (e.g. 4 for DETA and 6 for lysine).

The carbonation rate (CR) is then calculated as:

$$TC ( \% ) = moles of {CO}_{2} / moles of initial {CO}_{2} \qquad ( 7 )$$

Dry Grinding (Neat Grinding) with Amino Acid

TABLE 2
Carbonation rate of the metal oxide and regeneration
rate of the amino acid - Dry route

| | | Carbonation rate | |
|---|---|---|---|
| Amino | Alkaline earth | of the alkaline | Regeneration rate |
| acid | metal oxide | earth metal oxide | of the amino acid |
| GlyK | CaO | 45% | 95% |
| LysK | CaO | 82% | 95% |
| CysK | CaO | 52% | 100% |
| GlyK | MgO | 8.9% | 99% |
| LysK | MgO | 21% | 98% |
| CysK | MgO | 16% | 100% |

LAG Grinding with Amino Acid

TABLE 3
Carbonation rate of the metal oxide and regeneration
rate of the amino acid - LAG route

| | | | Carbonation | |
|---|---|---|---|---|
| | Alkaline | Distilled water | rate of the | Regeneration |
| Amino | earth metal | (μl/mg of total | alkaline earth | rate of the |
| acid | oxide | solid) | metal oxide | amino acid |
| LysK(s) | MgO | 0.5 | 41% | 92% |
| | MgO | 1.0 | 37% | 87% |
| | MgO | 2.0 | 31% | 94% |

LAG Grinding with Amine

TABLE 4
Carbonation rate of the Metal oxide and regeneration
rate of the amine - LAG route

| | | | Carbonation | |
|---|---|---|---|---|
| | | Distilled water | rate of the | Regeneration |
| | Alkaline earth | (μl/mg of metal | alkaline earth | rate of the |
| Amine | metal oxide | oxide) | metal oxide | Amine |
| DETA | CaO | 2.56 | 51% | 93% |
| DETA | MgO | 3.89 | 17% | 94% |

### 1.3—Conclusion

The obtained experimental results confirm that the method according to the present invention makes it possible to carry out the step of carbonating the alkaline earth metal oxide by dry route or in the presence of very small quantities of water, which significantly limits the quantities of water required in comparison with the methods conventionally implemented.

Furthermore, the reaction kinetics, the carbonation rate of the alkaline earth metal oxide and the regeneration rate of the amino acid or amine used are significantly higher than for conventionally used method (see for example Liu et al., “Single-step, low temperature and integrated CO₂ capture and conversion using sodium glycinate to produce calcium carbonate”, Fuel (2020), Ed. 275, 117887, or Liu et al., “Integrated CO₂ Capture and Removal via Carbon Mineralization with Inherent Regeneration of Aqueous Solvents”, Energy & Fuels (2021), 35 (9), 8051-8068)).

1. A method for trapping and storing CO₂ by mechanochemical route comprising the following steps:
a) dissolving an amine or an amino acid in order to obtain a concentrated solution whose concentration of amine function is at least 3M;
b) bringing the solution thus obtained into contact with a CO₂-containing gas;
c) 1. bringing into contact, while stirring, the concentrated solution obtained in step b) with an oxide, a hydroxide, a silicate, an aluminate, a phosphate, a chloride or a sulfate of alkaline earth metal or a material containing an oxide, a silicate, an aluminate, a phosphate, a chloride or a sulfate of alkaline earth metal, the energy implemented for stirring being at least 2.5 W per gram of the stirred sample;
or
2. bringing into contact under grinding the precipitate obtained in step b) with an oxide, a hydroxide, a silicate, an aluminate, a phosphate, a chloride or a sulfate of alkaline earth metal or a material containing an oxide, a silicate, an aluminate, a phosphate, a chloride or a sulfate of an alkaline earth metal, the energy implemented for grinding being at least 2.5 W per gram of the ground sample; and
d) washing the obtained solid.

2. The method according to claim 1, wherein the concentration of amine function of the concentrated solution obtained in step a) is at least 5M.

3. The method according to claim 1, wherein the energy implemented for stirring or grinding during step c) is at least 5 W per gram of sample.

4. The method according to claim 1, wherein the energy implemented for stirring or grinding during step c) is at most 500 W per gram of sample.

5. The method according to claim 1, wherein step c.2) is preceded by a step of filtering and washing the precipitate obtained in step b).

6. The method according to claim 1, wherein the amine is chosen as being ethylenediamine (EDA), diethylenetriamine (DETA), monoethanolamine (MEA), diethanolamine (DEA), N-methyldiethanolamine (MDEA), 2-amino-2methylpropanol (AMP), piperazine or 1,8-diazabicyclo[5.4.0]undec-7-ene (DBU).

7. The method according to claim 1, wherein the amino acid is chosen as being a proteinogenic amino acid.

8. The method according to claim 7, wherein the amino acid is chosen as being L-arginine (L-Arg), L-asparagine (L-Asn), L-aspartate (L-Asp), L-cysteine (L-Cys), glycine (Gly), histidine (His) or L-lysine (L-Lys), as well as their alkaline salts.

9. The method according to claim 8, wherein the amino acid is chosen as being L-lysine (L-Lys).

10. The method according to claim 1, wherein the organic solution is a water/alcohol mixture in a water:alcohol ratio comprised between 1:10 and 10:1.

11. The method according to claim 1, wherein the CO₂-containing gas is a combustion or industrial exhaust gas.

12. The method according to claim 11, wherein the CO₂-containing gas is an exhaust gas from a cement plant.

13. The method according to claim 1, wherein the precipitate obtained at the end of step c) is brought into contact with an alkaline earth metal oxide or silicate or a material containing an alkaline earth metal oxide or silicate.

14. The method according to claim 13, wherein the alkaline earth metal oxide is chosen as being CaO or MgO.

15. The method according to claim 13, wherein the alkaline earth metal silicate is chosen as being CaSiO₃ or MgSiO₃.

16. The method according to claim 13, wherein the alkaline earth metal hydroxide is chosen as being Ca(OH)₂ or Mg(OH)₂.
